(19) United States
(12) Patent Application Publication
(10) Pub. No.: US 2025/0042802 A1
(43) Pub. Date: Feb. 6, 2025

(54) PHOTOSENSITIVE GLASS AND PRODUCTION METHOD THEREFOR

(71) Applicant: AGC Inc., Tokyo (JP)

(72) Inventors: Nobuo INUZUKA, Shizuoka (JP); Daichi SHIRAI, Shizuoka (JP)

(73) Assignee: AGC Inc., Tokyo (JP)

(21) Appl. No.: 18/790,697

(22) Filed: Jul. 31, 2024

(30) Foreign Application Priority Data
Jul. 31, 2023 (JP) 2023-124791

(51) Int. Cl. C03C 4/04; C03C 3/068; C03C 3/118

(52) U.S. Cl. CPC C03C 4/04; C03C 3/068; C03C 3/118; C03C 2203/10; C03C 2203/52

(57) ABSTRACT

The present invention relates to a photosensitive glass, having a β-OH value of 0.20/mm or less. The present invention also relates to the photosensitive glass, having a difference between a crystal precipitation temperature after an exposure and a crystal precipitation temperature before the exposure of 10° C. or more, the exposure being performed so that a cumulative amount of a light having a wavelength of 280 nm to 360 nm is 2 J/cm² or more.

### ROSS-REFERENCE TO RELATED APPLICATIONS

This application is based on and claims priority under 35 USC 119 from Japanese Patent Application No. 2023-124791 filed on Jul. 31, 2023, the contents of which are incorporated herein by reference.

### TECHNICAL FIELD

The present invention relates to a photosensitive glass and a production method therefor.

### BACKGROUND ART

A photosensitive glass is a glass in which a glass structure of an exposed portion changes by combining light irradiation and a heat treatment. Specifically, when heat is applied to a glass that has been exposed to radiation of short wavelength such as ultraviolet rays, a Ag colloid is formed in the exposed portion, and the Ag colloid acts as a nucleus to precipitate fine crystals, which can change a color, a refractive index, chemical durability, and glass strength of the exposed portion (for example, Patent Literature 1).

The photosensitive glass includes a glass in which a NaF (sodium fluoride) crystal is precipitated as the fine crystal and a glass in which a Li₂SiO₃/Li₂Si₂O₅ (lithium silicate) crystal is precipitated as the fine crystal. The photosensitive glass in which a NaF crystal is precipitated is used in a volume holographic grating and the like, and the photosensitive glass in which a lithium silicate crystal is precipitated is used in a circuit board for high frequency applications and the like.
Patent Literature 1: JP2017-36200A

### SUMMARY OF INVENTION

Since it is necessary for the photosensitive glass to precipitate crystals in a fine pattern shape depending on the use, it is required to form a pattern shape with high accuracy and to provide sufficient properties due to crystal precipitation.

Therefore, an object of the present invention is to provide a photosensitive glass that can be patterned with high accuracy when subjected to an exposure and a heat treatment.

During the exposure and the heat treatment, in order to obtain a photosensitive glass that can be patterned with high accuracy, it is important to provide a clear difference in crystal precipitation temperature between an exposed portion and an unexposed portion. It is generally known that such a difference in crystal precipitation temperature is influenced by a glass composition. However, the inventors of the present invention have newly found that controlling a β-OH value in the photosensitive glass is also effective in adjusting the difference in crystal precipitation temperature. Thus, the present invention has been completed.

Namely, an aspect of the present invention relates to a photosensitive glass, having a β-OH value of 0.20/mm or less.

An aspect of the present invention relates to a production method for a photosensitive glass, the method including: heating a glass raw material containing a photosensitizer component to obtain a molten glass; molding the molten glass into a desired shape; and annealing the molded glass, in which the method further includes lowering a β-OH value of the photosensitive glass.

According to an aspect of the present invention, it is possible to provide a clear difference in crystal precipitation temperature between an exposed portion and an unexposed portion in the photosensitive glass. For example, even with a photosensitive glass having a uniform composition, the difference in crystal precipitation temperature can be widened. Alternatively, even when the glass composition has a narrow difference in crystal precipitation temperature, the difference in crystal precipitation temperature can be widened to a practically acceptable range. Therefore, it is possible to provide a photosensitive glass that can be patterned with high accuracy when subjected to an exposure and a heat treatment, and a production method therefor.

### BRIEF DESCRIPTION OF DRAWINGS

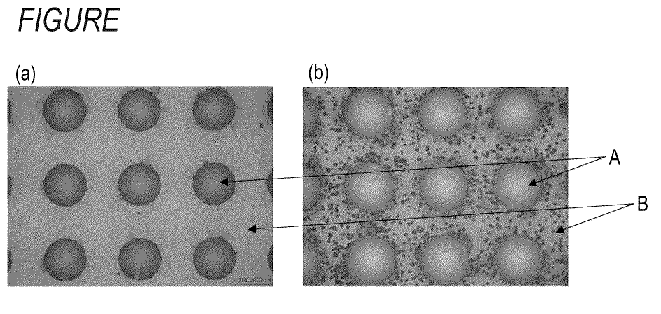

(a) and (b) of the FIGURE are micrographs of microfabrication type glasses in Examples after microfabrication. (a) of the FIG. 1s a micrograph of a microfabrication type glass in Example 14 after microfabrication, and (b) of the FIG. 1s micrograph of a microfabrication type glass in Example 15 after microfabrication.

### DESCRIPTION OF EMBODIMENTS

Hereinafter, the present invention will be described in detail, but the present invention is not limited to the following embodiment and can be freely modified and implemented without departing from the gist of the present invention.

In the present description, “to” indicating a numerical range is used in the sense of including the numerical values set forth before and after the “to” as a lower limit value and an upper limit value, unless otherwise specified.

In the present description, a “photosensitive glass” refers to a glass in which a metal colloid is generated in the glass and crystals are further precipitated by an exposure and a heat treatment. More specifically, the “photosensitive glass” causes a chemical reaction by an exposure, and Ag ions contained in the photosensitive glass receive electrons to become metal atoms. Thereafter, the photosensitive glass is subjected to a heat treatment to generate a silver colloid, and by further raising the temperature and performing a heat treatment, crystals are precipitated with the silver colloid as a nucleus.

Examples of a photosensitive glass according to one embodiment of the present invention includes a photosensitive glass in which a NaF crystal is precipitated as a main crystal by an exposure and a heat treatment. Since the refractive index of the glass changes in a region where the NaF crystal is precipitated, such a glass can be suitably used, for example, in a volume holographic grating. In the present description, the “main crystal” means a crystal that precipitates in the largest amount among crystals precipitated by an exposure and a heat treatment.

In the present description, a photosensitive glass in which a NaF crystal is precipitated as a main crystal by an exposure and a heat treatment is referred to as a “refractive index variable type glass”.

Examples of a photosensitive glass according to another embodiment of the present invention include a photosensitive glass in which a lithium silicate crystal such as a Li₂SiO₃ crystal or a Li₂Si₂O₅ crystal is precipitated as a main crystal by an exposure and a heat treatment. Since the crystal of the photosensitive glass in which the lithium silicate crystal is precipitated has a very high solubility in HF, the exposed portion can be selectively removed by HF etching, thereby forming fine patterns.

In the present description, a photosensitive glass in which a lithium silicate crystal is precipitated as a main crystal by an exposure and a heat treatment is referred to as a “microfabrication type glass”.

In the present description, a “photosensitive glass according to the present invention” or a “photosensitive glass according to the present embodiment” includes the refractive index variable type glass and the microfabrication type glass.

The above NaF crystal and lithium silicate crystal can be identified by, for example, X-ray diffraction measurement (XRD). Specifically, they can be identified by measurement by XRD using CuKα rays at 2θ=10° to 90° and comparing the obtained a plurality of diffraction peaks with a CSD (Cambridge structural database) or ICSD (inorganic crystal structure database).

### <Photosensitive Glass>

The photosensitive glass according to the present embodiment has a β-OH value of 0.20/mm or less.

The β-OH value means an absorbance due to hydroxy groups. Therefore, by evaluating the β-OH value, a content of water (and/or hydroxide ions, hereinafter simply referred to as “water”) in the glass can be evaluated. That is, a glass having a large β-OH value means to have a high content of water in the glass. In the present description, the β-OH value is calculated according to the following equation.

β-OH value (/mm)=(absorbance at 3570 cm⁻¹−absorbance at 3845 cm⁻¹)/t

Here, t means a thickness (mm) of the photosensitive glass, and the higher the β-OH value, the higher the content of water in the glass. The absorbance can be measured, for example, by Fourier transform infrared spectroscopy.

The specific measurement of the β-OH value will be described later.

The inventors of the present invention have found that when the β-OH value of the photosensitive glass is controlled, a difference in crystal precipitation temperature between an unexposed portion and an exposed portion can be adjusted. When the difference in crystal precipitation temperature between the unexposed portion and the exposed portion is sufficiently increased, problems such as precipitation of crystals in unnecessary portions can be avoided, so that fine patterns can be formed with high accuracy. The followings are possible reasons why the difference in crystal precipitation temperature can be controlled by adjusting the β-OH value of the photosensitive glass.

First, the reasons include an influence of the β-OH value on the photosensitive glass before a photosensitive treatment, that is, an influence of the β-OH value on crystal precipitation properties of the photosensitive glass itself. It is presumed that when the OH group is present in the glass, a Si—O—Si network is ruptured, an energy barrier required for crystal precipitation from the glass is lowered, and the crystal precipitation temperature of the glass itself is decreased.

The reasons also include an influence of the β-OH value on the photosensitive glass after a photosensitive treatment. In the photosensitive glass after the photosensitive treatment, an Ag colloid is formed in a photosensitive portion, and by using this Ag colloid as a crystal nucleus, the energy barrier for crystal precipitation is lowered and selective crystal precipitation is made possible. Since a decrease in the crystal precipitation temperature due to the above is greater than the effect caused by the β-OH value, the crystal precipitation temperature after the photosensitive treatment does not depend on the β-OH value. Therefore, it is presumed that the difference in crystal precipitation temperature due to the presence or absence of a photosensitive treatment decreases as the β-OH value increases, and it increases as the β-OH value decreases.

The photosensitive glass according to the present embodiment is not interpreted to be limited to the above mechanism of action.

In the present embodiment, when the β-OH value is 0.20/mm or less, the difference in crystal precipitation temperature between the unexposed portion and the exposed portion can be sufficiently increased, so that fine patterns can be formed with high accuracy. The β-OH value of the photosensitive glass according to the present embodiment is preferably 0.15/mm or less, more preferably 0.10/mm or less, still more preferably 0.080/mm or less, particularly preferably 0.060/mm or less, and most preferably 0.050/mm or less.

In addition, from the viewpoint of effectiveness of measures to lower the β-OH value, the β-OH value is preferably 0.005/mm or more.

The β-OH value can be adjusted, for example, by adjusting a melting temperature and a melting time of glass raw materials during glass production, a type of a raw material, or the like. Specifically, it can be adjusted by a method described in <Production Method for Photosensitive Glass> to be described later.

In the photosensitive glass according to the present embodiment, a difference between a crystal precipitation temperature after an exposure that is performed so that a cumulative amount of a light having a wavelength of 280 nm to 360 nm is 2 J/cm² or more and a crystal precipitation temperature before the exposure (hereinafter, referred to as a “difference in crystal precipitation temperature”) is preferably 10° C. or more.

When the difference in crystal precipitation temperature is 10° C. or more, the difference in crystal precipitation temperature between the unexposed portion and the exposed portion can be sufficiently increased, so that problems such as formation of crystals in unnecessary portions can be avoided, and patterning with high accuracy is made possible. The difference in crystal precipitation temperature is more preferably 12° C. or more, still more preferably 14° C. or more, even more preferably 16° C. or more, particularly preferably 18° C. or more, and even still more preferably 20° C. or more.

The larger the difference in crystal precipitation temperature, the better. Therefore, the upper limit is not particularly limited, and is, for example, 50° C. or less.

The crystal precipitation temperature can be measured, for example, by differential thermal analysis or XRD.

More specifically, the crystal precipitation temperature of the refractive index variable type glass can be calculated by differential thermal analysis (for example, Thermo plus TG8120 manufactured by RIGAKU Corporation) and differential scanning calorimetry (for example, Thermo Plus EVO2 DSC8271 manufactured by RIGAKU Corporation). In this case, under conditions that a sample weight is 30 mg to 60 mg, a heating rate is 10° C./min, an extrapolation temperature of an inflection point at which heat generation starts is defined as the crystal precipitation temperature on an exothermic peak due to crystal precipitation under uniform heating. The extrapolation temperature is an intersection temperature of an extension line of a portion where there is no change in amount of heat before heat generation occurs and an extension line of a point where a gradient of the change in amount of heat after the start of heat generation is the maximum.

The crystal precipitation temperature of the microfabrication type glass may also be calculated by differential thermal analysis and differential scanning calorimetry, similar to the refractive index variable type glass. In the case where the crystal precipitation temperature of the microfabrication type glass cannot be measured by differential thermal analysis and differential scanning calorimetry, a glass heated at a constant temperature at a plurality of temperature levels is subjected to X-ray diffraction spectroscopy (for example, SmartLab X-RAY DIFFRACTMETER manufactured by RIGAKU Corporation), and a temperature at which a diffraction peak derived from a Li₂SiO₃ crystal occurs is defined as the crystal precipitation temperature.

The above exposure can be performed using a high-pressure mercury lamp (for example, ultra-high-pressure mercury lamp USH-250BY manufactured by Ushio Inc.) or a photochemical mercury lamp (for example, H-400P manufactured by Toshiba Corporation), based on a UV illuminance measured by attaching a UV cumulative photometer (for example, UIT-250 manufactured by Ushio Inc.) and a light receiver (for example, UVD-S313 (sensitivity wavelength: 280 nm to 360 nm) manufactured by Ushio Inc.).

### (Glass Composition)

Next, one embodiment of a composition range of components that can be included in the photosensitive glass according to the present embodiment will be described in detail. Note that, in the case where the composition range of the component is expressed as “%” or “ppm”, unless otherwise specified, the composition range means mass % or ppm by mass. In addition, “being substantially free of” a component means that the component is not included except for inevitable impurities mixed from raw materials and the like, that is, the component is not intentionally included.

The photosensitive glass according to the present embodiment preferably includes 0.001% to 5% of Ag₂O in mass %.

Ag₂O is a photosensitizer component that serves as a starting point of crystal growth to selectively crystallize the exposed portion, that is, a nucleus source. When the photosensitive glass according to the present embodiment includes 0.001% or more of Ag₂O, the exposed portion can be selectively crystallized. The content of Ag₂O is more preferably 0.005% or more, still more preferably 0.008% or more, even more preferably 0.01% or more, particularly preferably 0.012% or more, even still more preferably 0.014% or more, and most preferably 0.015% or more.

In addition, in the photosensitive glass according to the present embodiment, the content of Ag₂O is preferably 5% or less. When the content of Ag₂O is 5% or less, a dissolution residue of Ag₂O in the glass can be prevented. Further, a burden on melting equipment can be reduced. The content of Ag₂O is more preferably 4% or less, still more preferably 3.5% or less, even more preferably 3% or less, particularly preferably 2.5% or less, even still more preferably 2% or less, yet still more preferably 1% or less, and most preferably 0.5% or less.

The photosensitive glass according to the present embodiment preferably includes 0.001% to 5% of CeO₂ in mass %.

CeO₂ is an optical sensitizer and is a component that makes a glass sensitive only to high-energy light such as X-rays become sensitive to ultraviolet rays. In addition, CeO₂ plays the role of emitting electrons upon receiving ultraviolet rays and supplying the electrons to Ag⁺ ions.

When the photosensitive glass according to the present embodiment includes 0.001% or more of CeO₂, sensitivity to the exposure can be improved. The content of CeO₂ is more preferably 0.003% or more, still more preferably 0.005% or more, even more preferably 0.01% or more, particularly preferably 0.013% or more, even still more preferably 0.015% or more, and most preferably 0.02% or more.

In addition, in the photosensitive glass according to the present embodiment, the content of CeO₂ is preferably 5% or less. When the content of CeO₂ is 5% or less, the sensitivity to the exposure does not become too high, problems such as unnecessary portions being exposed can be avoided, and the pattern accuracy is improved. The content of CeO₂ is more preferably 4% or less, still more preferably 3.5% or less, even more preferably 3% or less, particularly preferably 2.5% or less, even still more preferably 2% or less, yet still more preferably 1% or less, and most preferably 0.5% or less.

The photosensitive glass according to the present embodiment preferably includes, in mass %:
20% to 80% of SiO₂,
1% to 20% of Al₂O₃,
0% to 20% of B₂O₃,
0% to 20% of Li₂O,
0% to 20% of Na₂O,
0% to 20% of K₂O,
1% to 20% of ZnO,
0% to 5% of F,
0% to 5% of Br,
0.001% to 0.5% of Ag₂O,
0.001% to 0.5% of CeO₂,
0% to 1.0% of Sb₂O₃, and
0% to 1.0% of SnO₂.

Hereinafter, a preferred composition range of each component included in the photosensitive glass according to the present embodiment will be described.

SiO₂ is a component that forms a glass skeleton with a network structure, and that improves acid resistance and water resistance and stabilizes the glass. It is also a component for forming and precipitating a Li₂SiO₃ crystal as a crystal phase in a microfabrication type glass. In the photosensitive glass according to the present embodiment, the content of SiO₂ is preferably 20% to 80%. When the content of SiO₂ is 20% or more, the glass is stabilized, and a precipitated crystal phase of the photosensitive glass is easily stabilized. In the photosensitive glass according to the present embodiment, the content of SiO₂ is more preferably 30% or more, still more preferably 40% or more, even more preferably 50% or more, particularly preferably 60% or more, even still more preferably 65% or more, and most preferably 70% or more.

In addition, when the content of SiO₂ is 80% or less, it is easy to melt or mold the glass raw material. The content of SiO₂ is more preferably 79% or less, still more preferably 78% or less, even more preferably 77% or less, particularly preferably 76% or less, and most preferably 75% or less.

In both a refractive index variable type glass and a microfabrication type glass, which are specific aspects of the photosensitive glass according to the present embodiment, the preferred range of the content of SiO₂ is the same as above.

Al₂O₃ is a component that is effective in improving acid resistance, increasing a Young's modulus, preventing phase separation of the glass, decreasing a coefficient of thermal expansion, and the like. In the photosensitive glass according to the present embodiment, the content of Al₂O₃ is preferably 1% to 20%. When the content of Al₂O₃ is 1% or more, stability of the glass is improved and deterioration due to weathering is prevented. The content of Al₂O₃ is more preferably 2% or more, still more preferably 2.5% or more, even more preferably 3% or more, particularly preferably 3.5% or more, even still more preferably 4% or more, and most preferably 5% or more.

In addition, the content of Al₂O₃ is preferably 20% or less. When the content of Al₂O₃ is 20% or less, crystal precipitation from the glass can be maintained. The content of Al₂O₃ is more preferably 18% or less, still more preferably 16% or less, even more preferably 14% or less, particularly preferably 12% or less, even still more preferably 10% or less, and most preferably 8% or less.

In both the refractive index variable type glass and the microfabrication type glass, which are specific aspects of the photosensitive glass according to the present embodiment, the preferred range of the content of Al₂O₃ is the same as above.

B₂O₃ is a component that is effective in improving the acid resistance and decreasing the coefficient of thermal expansion. In the photosensitive glass according to the present embodiment, the content of B₂O₃ is preferably 0% to 20%. When the photosensitive glass according to the present embodiment includes B₂O₃, the stability of the glass is improved and the deterioration due to weathering can be prevented. In the microfabrication type glass, preventing etching of the glass has the effect of improving the pattern shape accuracy in etching. The content of B₂O₃ is more preferably 0.1% or more, still more preferably 0.3% or more, even more preferably 0.5% or more, particularly preferably 1% or more, even still more preferably 2% or more, and most preferably 3% or more.

In addition, the content of B₂O₃ is preferably 20% or less. When the content of B₂O₃ is 20% or less, variations in crystal precipitation properties due to phase separation can be prevented. The content of B₂O₃ is more preferably 18% or less, still more preferably 16% or less, even more preferably 14% or less, particularly preferably 12% or less, even still more preferably 10% or less, and most preferably 8% or less.

In both the refractive index variable type glass and the microfabrication type glass, which are specific aspects of the photosensitive glass according to the present embodiment, the preferred range of the content of B₂O₃ is the same as above.

Li₂O is a component that lowers a viscosity of the glass and improves meltability, but when it is added too much, a silica network structure is excessively fragmented and the stability of the glass is decreased. It is also a component for forming and precipitating a lithium silicate crystal such as a Li₂SiO₃ crystal and a Li₂Si₂O₅ crystal in the microfabrication type glass. The photosensitive glass according to the present embodiment preferably includes 0% to 20% of Li₂O). When the photosensitive glass according to the present embodiment includes Li₂O, a lithium silicate crystal is easily obtained, and the precipitated crystal phase is easily stabilized. The content of Li₂O is more preferably 3% or more, still more preferably 4% or more, even more preferably 5% or more, particularly preferably 7% or more, even still more preferably 7.5% or more, and most preferably 8% or more.

In addition, when the content of Li₂O is 20% or less, the stability of the glass is maintained. The content of Li₂O is more preferably 19% or less, still more preferably 18% or less, even more preferably 17% or less, particularly preferably 16% or less, and even still more preferably 15% or less.

In the refractive index variable type glass, which is a specific aspect of the photosensitive glass according to the present embodiment, the preferred range of the content of Li₂O is the same as above. However, in order to precipitate a NaF crystal alone, the content of Li₂O is preferably 0% to 3%.

On the other hand, in the microfabrication type glass, the content of Li₂O is preferably 1% to 20%. In the microfabrication type glass, when the content of Li₂O is 1% or more, precipitation of a lithium silicate crystal is promoted. In the microfabrication type glass, the content of Li₂O is more preferably 3% or more, still more preferably 4% or more, even more preferably 5% or more, particularly preferably 7% or more, even still more preferably 7.5% or more, and most preferably 8% or more.

In the microfabrication type glass, the preferred range of the upper limit value of the content of Li₂O is the same as that of the refractive index variable type glass.

Na₂O is a component that lowers the viscosity of the glass and improves the meltability of the glass, but when it is added too much, the silica network structure is excessively fragmented and the stability of the glass is decreased. It is also a component that contributes to decreasing a dielectric loss when added in mixture with Li₂O or K₂O. It is a component for forming and precipitating a NaF crystal in the refractive index variable type glass. In the photosensitive glass according to the present embodiment, the content of Na₂O is preferably 0% to 20%. When the photosensitive glass according to the present embodiment includes Na₂O, the meltability of the glass is improved, and in the coexistence with fluorine (F), the NaF crystal is easily obtained and the precipitated crystal phase is easily stabilized. The content of Na₂O is more preferably 1% or more, still more preferably 2% or more, even more preferably 3% or more, particularly preferably 4% or more, even still more preferably 5% or more, and most preferably 5.5% or more.

In addition, when the content of Na₂O) is 20% or less, the stability of the glass is maintained, and the deterioration due to weathering can be prevented. The content of Na₂O is more preferably 19% or less, still more preferably 18% or less, and even more preferably 17% or less.

In the microfabrication type glass, which is a specific aspect of the photosensitive glass according to the present embodiment, the preferred range of the content of Na₂O is the same as above.

On the other hand, in the refractive index variable type glass, the content of Na₂O is preferably 1% to 20%. In the refractive index variable type glass, when the content of Na₂O is 1% or more, precipitation of the NaF crystal is promoted. In the refractive index variable type glass, the content of Na₂O is more preferably 5% or more, still more preferably 8% or more, even more preferably 10% or more, particularly preferably 12% or more, even still more preferably 14% or more, and most preferably 15% or more.

In the refractive index variable type glass, the preferred range of the upper limit value of the content of Na₂O is the same as that of the microfabrication type glass.

K₂O is a component that lowers the viscosity of the glass and improves the meltability of the glass, but when it is added too much, the silica network structure is excessively fragmented and the stability of the glass is decreased. It is also a component that contributes to decreasing the dielectric loss when added in mixture with Li₂O or Na₂O. In addition, it is a component that facilitates the precipitation of a Li₂SiO₃ crystal in the microfabrication type glass. In the photosensitive glass according to the present embodiment, the content of K₂O is preferably 0% to 20%. When the photosensitive glass according to the present embodiment includes K₂O, the meltability of the glass is improved. The content of K₂O is more preferably 1% or more, still more preferably 2% or more, even more preferably 3% or more, particularly preferably 4% or more, even still more preferably 5% or more, and most preferably 6% or more.

In addition, when the content of K₂O is 20% or less, the stability of the glass is maintained, and the deterioration due to weathering can be prevented. The content of K₂O is more preferably 18% or less, still more preferably 16% or less, even more preferably 14% or less, particularly preferably 12% or less, even still more preferably 11% or less, and most preferably 10% or less.

In both the refractive index variable type glass and the microfabrication type glass, which are specific aspects of the photosensitive glass according to the present embodiment, the preferred range of the content of K₂O is the same as above.

ZnO is a component that increases the solubility of Ag₂O. In addition, ZnO may be effective in improving the chemical durability, preventing undesired reduction of silver, and the like. In the photosensitive glass according to the present embodiment, the content of ZnO is preferably 1% to 20%. When the photosensitive glass according to the present embodiment includes 1% or more of ZnO, only enough silver can be dissolved to develop sufficient photosensitivity for selective crystal precipitation. The content of ZnO is more preferably 1.2% or more, still more preferably 1.4% or more, particularly preferably 1.5% or more, even more preferably 1.7% or more, and most preferably 1.8% or more.

In addition, the content of ZnO is 20% or less, a decrease in crystallization tendency can be prevented. The content of ZnO is more preferably 18% or less, still more preferably 16% or less, even more preferably 14% or less, particularly preferably 12% or less, even still more preferably 11% or less, and most preferably 10% or less.

In both the refractive index variable type glass and the microfabrication type glass, which are specific aspects of the photosensitive glass according to the present embodiment, the preferred content of ZnO is the same as above.

Fluorine (F) is a component that precipitates a NaF crystal and is a component that also improves the meltability of the glass. In the photosensitive glass according to the present embodiment, the content of F is preferably 0% to 5%. When the photosensitive glass according to the present embodiment includes F, the NaF crystal is easily obtained, and the precipitated crystal phase is easily stabilized. The content of F is more preferably 0.5% or more, still more preferably 1% or more, even more preferably 1.5% or more, particularly preferably 2% or more, even still more preferably 2.3% or more, and most preferably 2.5% or more.

In addition, when the content of F is 5% or less, it is possible to prevent devitrification during molding due to an excessive precipitation tendency of the NaF crystal. The content of F is more preferably 4.5% or less, still more preferably 4% or less, and even more preferably 3.5% or less.

Particularly in the refractive index variable type glass, which is a specific aspect of the photosensitive glass according to the present embodiment, the content of F is preferably 0.1% to 5%. In the refractive index variable type glass, when the content of F is 0.1% or more, the precipitation tendency of the NaF crystal can be promoted. In the refractive index variable type glass, the content of F is more preferably 0.5% or more, still more preferably 1% or more, even more preferably 1.5% or more, particularly preferably 2% or more, even still more preferably 2.3% or more, and most preferably 2.5% or more.

In the refractive index variable type glass, the preferred range of the upper limit value of the content of F is the same as above.

It is preferable that the microfabrication type glass, which is a specific aspect of the photosensitive glass according to the present embodiment, is substantially free of F. That is, in the microfabrication type glass, the content of F is preferably 100 ppm or less.

Bromine (Br) is a component that promotes dissolution of a silver component into the glass. In addition, in the coexistence with fluorine (F), it also has the effect of facilitating precipitation of the NaF crystal. In the photosensitive glass according to the present embodiment, the content of Br is preferably 0% to 5%. When the photosensitive glass according to the present embodiment includes Br, the NaF crystal is easily obtained, and the precipitated crystal phase is easily stabilized. The content of Br is more preferably 0.1% or more, still more preferably 0.3% or more, even more preferably 0.5% or more, particularly preferably 0.7% or more, even still more preferably 0.9% or more, and most preferably 0.95% or more.

In addition, when the content of Br is 5% or less, it is possible to prevent devitrification during molding due to an excessive precipitation tendency of the NaF crystal. The content of Br is more preferably 4% or less, still more preferably 3.5% or less, even more preferably 3% or less, particularly preferably 2.5% or less, even still more preferably 2.2% or less, and most preferably 2% or less.

Particularly in the refractive index variable type glass, which is a specific aspect of the photosensitive glass according to the present embodiment, the content of Br is preferably 0.1% to 5%. In the refractive index variable type glass, when the content of Bris 0.1% or more, the precipitation tendency of the NaF crystal can be promoted. In the refractive index variable type glass, the content of Br is more preferably 0.3% or more, still more preferably 0.5% or more, even more preferably 0.7% or more, particularly preferably 0.9% or more, and even still more preferably 0.95% or more.

In the refractive index variable type glass, the preferred range of the upper limit value of the content of Br is the same as above.

On the other hand, the microfabrication type glass, which is a specific aspect of the photosensitive glass according to the present embodiment, may be substantially free of Br. That is, in the microfabrication type glass, the content of Br may be 100 ppm or less.

Sb₂O₃ is a thermally reducible component and reduces metal ions during a heat treatment. In the present embodiment, Sb₂O₃ acts to reduce Ag ions in a high temperature range. In the photosensitive glass according to the present embodiment, the content of Sb₂O₃ is preferably 0% to 1.0%. When Sb₂O₃ is included, reduction of the metal ions during a heat treatment can be performed stably. The content of Sb₂O₃ is more preferably 0.05% or more, still more preferably 0.08% or more, even more preferably 0.1% or more, particularly preferably 0.13% or more, even still more preferably 0.15% or more, and most preferably 0.18% or more.

In addition, when the content of Sb₂O₃ is 1.0% or less, coloring of the glass can be prevented. The content of Sb₂O₃ is more preferably 0.95% or less, still more preferably 0.9% or less, even more preferably 0.85% or less, particularly preferably 0.8% or less, even still more preferably 0.75% or less, and most preferably 0.7% or less.

In the refractive index variable type glass, which is a specific aspect of the photosensitive glass according to the present embodiment, the preferred range of the content of Sb₂O₃ is the same as above.

On the other hand, in the microfabrication type glass, which is a specific aspect of the photosensitive glass according to the present embodiment, the content of Sb₂O₃ is preferably 0.01% to 1.0%. In the microfabrication type glass, when the content of Sb₂O₃ is 0.01% or more, Ag ions are reduced and formation of the Ag colloid is promoted by the heat treatment after the exposure. In the microfabrication type glass, the content of Sb₂O₃ is more preferably 0.05% or more, still more preferably 0.08% or more, even more preferably 0.1% or more, particularly preferably 0.13% or more, even still more preferably 0.15% or more, and most preferably 0.18% or more.

In the microfabrication type glass, the preferred range of the upper limit value of the content of Sb₂O₃ is the same as that of the refractive index variable type glass.

Similar to Sb₂O₃, SnO₂ is a thermally reducible component and reduces metal ions during a heat treatment. In the present embodiment, SnO₂ serves to reduce Ag⁺ ions in a high temperature range. The coexistence of SnO₂ with Sb₂O₃ further enhances a thermal reduction effect. In the photosensitive glass according to the present embodiment, the content of SnO₂ is preferably 0% to 1.0%. When the photosensitive glass according to the present embodiment includes SnO₂, the formation of the Ag colloid is promoted by the heat treatment after the exposure. The content of SnO₂ is more preferably 0.001% or more, still more preferably 0.01% or more, even more preferably 0.02% or more, particularly preferably 0.03% or more, even still more preferably 0.04% or more, and most preferably 0.05% or more.

In addition, when the content of SnO₂ is 1.0% or less, there is no risk that the function as a photosensitive glass is impaired, such as the reduction effect for metal ions being excessive and the Ag colloid being formed. The content of SnO₂ is more preferably 0.5% or less, still more preferably 0.4% or less, even more preferably 0.3% or less, particularly preferably 0.2% or less, even still more preferably 0.15% or less, and most preferably 0.1% or less.

In both the refractive index variable type glass and the microfabrication type glass, which are specific aspects of the photosensitive glass according to the present embodiment, the preferred content of SnO₂ is the same as above.

The refractive index variable type glass, which is a specific aspect of the photosensitive glass according to the present embodiment, preferably satisfies the following composition.

The refractive index variable type glass may include, in mass %:
20% to 80% of SiO₂,
1% to 20% of Al₂O₃,
0% to 20% of B₂O₃,
0% to 20% of Li₂O,
1% to 20% of Na₂O,
0% to 20% of K₂O,
1% to 20% of ZnO,
0.1% to 5% of F,
0.1% to 5% of Br,
0.001% to 0.5% of Ag₂O,
0.001% to 0.5% of CeO₂,
0% to 1.0% of Sb₂O₃, and
0% to 1.0% of SnO₂.

In addition, the microfabrication type glass, which is another specific aspect of the photosensitive glass according to the present embodiment, preferably satisfies the following composition.

The microfabrication type glass may include, in mass %:
20% to 80% of SiO₂,
1% to 20% of Al₂O₃,
0% to 20% of B₂O₃,
1% to 20% of Li₂O,
0% to 20% of Na₂O,
0% to 20% of K₂O,
1% to 20% of ZnO,
0.001% to 0.5% of Ag₂O,
0.001% to 0.5% of CeO₂,
0.01% to 1.0% of Sb₂O₃, and
0% to 1.0% of SnO₂.

It is preferable that the photosensitive glass according to the present embodiment is substantially free of Cr, Ni, V, Mn, and Co. That is, the content of Cr, Ni, V, Mn, and Co may be 5 ppm or less. This is because Cr, Ni, V, Mn, and Co are coloring components and have a problem of deteriorating a transmittance, particularly in the refractive index variable type glass. In addition, Cr, V, Mn, and Co, which are coloring components that absorb UV, may cause problems in the formation of the Ag colloid.

The photosensitive glass according to the present embodiment may include components other than the above components (hereinafter referred to as “other components”) within a range that does not impede the effects of the present invention. Examples of other components include Rb₂O, Cs₂O, MgO, CaO, SrO, BaO, P₂O₅, GeO₂, Sc₂O₃, Y₂O₃, La₂O₃, Pr₂O₃, Nd₂O₃, Pm₂O₃, Sm₂O₃, Eu₂O₃, Gd₂O₃, Tb₂O₃, Dy₂O₃, Ho₂O₃, TiO₂, Fe₂O₃, ZrO₂, Nb₂O₅, MoO₃, HfO₂, Ta₂O₃, and WO₃. The total content of these components is preferably 5% or less, more preferably 4% or less, still more preferably 3% or less, even more preferably 2% or less, particularly preferably 1% or less, even still more preferably 0.5% or less, and most preferably 0.1% or less.

In the refractive index variable type glass and the microfabrication type glass, which are specific aspects of the photosensitive glass according to the present embodiment, the preferred content of the other components is the same as above.

### <Production Method for Photosensitive Glass>

Next, the production method for a photosensitive glass according to the present embodiment will be described. The production method for a photosensitive glass according to the present embodiment includes heating a glass raw material containing a photosensitizer component to obtain a molten glass (melting step), molding the molten glass into a desired shape (molding step), and annealing the molded glass (annealing step), and the method further includes lowering a β-OH value of the photosensitive glass (a β-OH value lowering step).

Hereinafter, the steps will be described.

The melting step is a step of heating a glass raw material containing a photosensitizer component to obtain a molten glass.

The photosensitizer component is a component capable of generating a nucleus serving as a starting point of crystal growth to selectively crystallize the exposed portion. Examples of the photosensitizer component include Ag₂O described above. Ag₂O is preferred because of having no absorption in a visible region, being easily dissolved in the glass, and having a low raw material cost.

Examples of the glass raw material include a homogeneous mixture of a metal oxide, a carbonate, a sulfate, a nitrate, glass cullet, or the like in the form of a powder or granules having appropriate particle size. The glass cullet is glass waste discharged during the glass production process.

A method for heating the glass raw material is not particularly limited, and examples thereof include a method in which the glass raw material is charged into a platinum crucible, and the platinum crucible is placed in an electric furnace, followed by heating and melting.

A melting temperature may be any temperature that can melt the glass raw material used, and may be, for example, 1400° C. to 1600° C., and preferably 1450° C. to 1550° C. In addition, a melting time may be, for example, 1 hour to 120 hours, and preferably 2 hours to 100 hours, depending on a melting scale (weight).

The molding step is a step of molding the molten glass obtained in the above melting step into a desired shape. The glass can be molded, for example, by pouring a molten glass into a preheated mold and solidifying the same into a desired shape. At this time, the glass can be molded into a plate shape, a tube shape, or the like by a down-draw method, a press method, or the like, or into a block shape, a column shape, or the like by billet molding or the like, or into a desired shape according to the use form using other molds.

The annealing step is a step of annealing the glass molded in the above molding step to room temperature.

In the present embodiment, in the annealing step, it is preferable to perform annealing at a cooling rate from a temperature T1 to a temperature T2 of 1° C./min or less. Here, T1 is a temperature at an annealing point (Ap), and T2 is a temperature at a strain point (Sp).

When the annealing is performed at a cooling rate from the temperature T1 to the temperature T2 of 1° C./min or less, a thermal strain inside the glass is removed and a variation in crystal precipitation can be prevented. The cooling rate from the temperature T1 to the temperature T2 is more preferably 0.9° C./min or less, still more preferably 0.7° C./min or less, and particularly preferably 0.5° C./min or less.

From the viewpoint of preventing glass devitrification during the annealing, the cooling rate from the temperature T1 to the temperature T2 is preferably greater than 0.1° C./min, more preferably 0.15° C./min or more, and still more preferably 0.2° C./min or more.

In the production method according to the present embodiment, even in the case where the temperature T1 is changed from the annealing point (Ap), it is preferable that the cooling rate from the temperature T1 to the temperature T2 satisfies the above range. At this time, a range of change in temperature T1 may be a range from [annealing point (Ap)+30° C.] to [annealing point (Ap)−10° C.]. When the temperature is raised too much, the glass may crystallize.

In addition, in the production method according to the present embodiment, even in the case where the temperature T2 is changed from the strain point (Sp), it is preferable that the cooling rate from the temperature T1 to the temperature T2 satisfies the above range. At this time, a range of change in temperature T2 may be within a range lower than the strain point (Sp).

In the production method according to the present embodiment, lowering the β-OH value means to reduce the amount of water in the glass. When the β-OH value lowering step is included, since the difference in crystal precipitation temperature of the obtained photosensitive glass can be controlled, a photosensitive glass that can be patterned with good accuracy can be obtained. The β-OH value lowering step may be performed during the melting step, the molding step, and the annealing step, as will be described later.

A method for lowering the β-OH value is not particularly limited as long as it can reduce the amount of water in the glass, and for example, the following methods (1) to (5) can be applied.
(1) A molten cullet rate is set to 10% or more in terms of molten-glass weight.
(2) A temperature during melting of the glass raw material is set to 1400° C. or higher.
(3) No hydrate, hydroxide, or deliquescent/hygroscopic raw material is used as the glass raw material.
(4) Melting is performed using a resistance heating electric furnace.
(5) A dry gas is introduced into the melting furnace to control a dew point of a melting area.

In the above (1), when the molten cullet rate is set to 10% or more in terms of molten weight, since the cullet once undergoes a molten state and has a reduced amount of water derived from raw materials, the β-OH value can be lowered than in the case where only raw materials are used. The molten cullet rate is more preferably 20% or more, still more preferably 30% or more, and particularly preferably 40% or more. In addition, from the viewpoint of adjusting the valence balance of metal ions in the molten glass, the molten cullet rate is preferably 70% or less, and more preferably 60% or less.

The cullet means glass waste that contains only desired components and can be adjusted to a desired composition by combining with raw materials.

In the above (2), when the temperature during melting of the glass raw material is set to 1400° C. or higher, a vapor pressure of water in the glass increases and volatilization is promoted, making it possible to lower the β-OH value. The temperature during melting of the glass raw material is more preferably 1450° C. or higher, still more preferably 1480° C. or higher, and particularly preferably 1500° C. or higher. When the temperature is too high, there is a risk that the function as a photosensitive glass is impaired, such as proceeding of the reduction of the metal ions in the glass and the formation of the Ag colloid. Therefore, the temperature during melting of the glass raw material is preferably 1600° C. or lower.

In the above (3), when no hydrate, hydroxide, or deliquescent/hygroscopic raw material is used, the amount of water in the glass raw material can be reduced, and the β-OH value of the glass can be lowered.

Examples of the hydrate include borax pentahydrate (Na₂B₄O₇/5H₂O) and aluminum nitrate hydrate (Al(NO₃)₃/9H₂O).

Examples of the hydroxide include aluminum hydroxide (Al(OH)₃), sodium hydroxide (NaOH), and potassium hydroxide (KOH).

Examples of the deliquescent/hygroscopic raw material include the above sodium hydroxide or potassium hydroxide, and lithium nitrate (LiNO₃).

In the above (4), the resistance heating electric furnace is an electric furnace that generates heat by passing electricity through a heating element such as molybdenum disilicide to heat a space inside the furnace, and does not generate water from the heat source, for example, unlike in a combustion heating furnace, so that the β-OH value can be efficiently lowered.

In the above (5), when a dry gas is supplied into the melting furnace to lower the dew point of the melting atmosphere and lower a partial pressure of water, the β-OH value of the finally obtained photosensitive glass can be lowered.

The type of the dry gas is not particularly limited, and any suitable gas such as oxygen, nitrogen, or air can be used. When the dew point of the melting area is controlled, the water in the glass raw material can be controlled within an appropriate range. The dew point of the melting area is preferably within a range of −70° C. to 20° C. When the dew point of the melting area is 10° C. or lower, the water in the glass can be easily controlled. When the dew point is 5° C. or lower, it is easy to adjust the β-OH value of the finally obtained photosensitive glass to a range of 0.15/mm. The dew point of the melting area is more preferably in a range of −70° C. to 0° C., and still more preferably −70° C. to −10° C.

The dew point can be adjusted by supplying a dry gas into the melting area (melting atmosphere).

The β-OH value lowering step is performed such that the obtained photosensitive glass has the β-OH value of preferably 0.20/mm or less, more preferably 0.15/mm or less, still more preferably 0.10/mm or less, even still more preferably 0.080/mm or less, particularly preferably 0.060/mm or less, and most preferably 0.050/mm or less. From the viewpoint of the effectiveness of measures to lower the β-OH value, the β-OH value lowering step is preferably performed such that the β-OH value is 0.005/mm or more.

### <Use>

The photosensitive glass according to the present embodiment can form a processed pattern with good accuracy when subjected to an exposure and a heat treatment, and can thus be suitably used for an optical element and a substrate for microfabrication. Examples of the optical element include a volume holographic grating, and examples of the substrate for microfabrication include a circuit board for high frequency applications, and a substrate for microchannel devices.

Particularly, the refractive index variable type glass according to a specific aspect of the photosensitive glass according to the present embodiment can periodically change the refractive indexes of the exposed portion and the unexposed portion by two-beam interference exposure, and can or will be particularly preferably used as a volume holographic grating.

In addition, the microfabrication type glass according to another specific aspect of the photosensitive glass according to the present embodiment can form fine patterns such as a through glass via (TGV) and a cavity by drawing fine patterns all at once using mask exposure and performing etching after crystal precipitation, and can thus be particularly suitably used for a circuit board for high frequency applications and a substrate for microchannel devices.

As described above, the following configurations are disclosed in the present description.

1. A photosensitive glass, having a β-OH value of 0.20/mm or less.

2. The photosensitive glass according to the above 1, having a difference between a crystal precipitation temperature after an exposure and crystal precipitation temperature before the exposure of 10° C. or more, the exposure being performed so that a cumulative amount of a light having a wavelength of 280 nm to 360 nm is 2 J/cm² or more.

3. The photosensitive glass according to the above 1 or 2, including, in mass %:
0.001% to 5% of Ag₂O, and
0.001% to 5% of CeO₂.

4. The photosensitive glass according to any one of the above 1 to 3, including, in mass %:
20% to 80% of SiO₂,
1% to 20% of Al₂O₃,
0% to 20% of B₂O₃,
0% to 20% of Li₂O,
0% to 20% of Na₂O,
0% to 20% of K₂O,
1% to 20% of ZnO,
0% to 5% of F,
0% to 5% of Br,
0.001% to 0.5% of Ag₂O,
0.001% to 0.5% of CeO₂,
0% to 1.0% of Sb₂O₃, and
0% to 1.0% of SnO₂.

5. The photosensitive glass according to any one of the above 1 to 4, being substantially free of Cr, Ni, V, Mn, and Co.

6. A production method for a photosensitive glass, the method including:
heating a glass raw material containing a photosensitizer component to obtain a molten glass;
molding the molten glass into a desired shape; and
annealing the molded glass,
in which the method further includes lowering a β-OH value of the photosensitive glass.

7. The production method for a photosensitive glass according to the above 6, in which
the annealing is performed at a cooling rate from a temperature T1 to a temperature T2 of 1° C./min or less, the temperature T1 means an annealing point temperature, and the temperature T2 means a strain point temperature.

### EXAMPLES

Hereinafter, the present invention will be described with reference to Examples, but the present invention is not limited Examples. Examples 1 to 14 are Working Examples, and Example 15 is Comparative Example.

### <Preparation of Photosensitive Glass>

### Examples 1 to 11: Refractive Index Variable Type Glass

Glass cullet including SiO₂, Al(OH)₃, NaCO₃, NaF, NaBr, K₂CO₃, ZnO, CeO₂, SnO, Sb₂O₃, and Ag was used as a raw material, was charged into an 8 L platinum crucible, and then heated and melted at 1500° C. for 24 hours with stirring. The homogeneously melted glass was poured into a cast iron mold, molded into a 20 mm thick plate, and annealed to obtain a refractive index variable type glass in each example. The melting was performed under the atmosphere and in an environment where dry air was introduced into the furnace, and the β-OH value was adjusted for each example. The β-OH value of each example is shown in Table 1. In addition, in Examples 1 to 11, the charged glass compositions were the same, but the composition of easily volatile components such as F and Br varied depending on the melting, so that the compositions of the obtained glasses were not the same. (Examples 12 to 15: microfabrication type glass)

Glass cullet including SiO₂, Li₂CO₃, NaCO₃, K₂CO₃, Al(OH)₃, B₂O₃, ZnO, CeO₂, Sb₂O₃, and Ag was used as a raw material, was charged into an 8 L platinum crucible, and then heated and melted at 1500° C. under the atmosphere for 24 hours with stirring. The homogeneously melted glass was poured into a cast iron mold, molded into a 20 mm thick plate, and annealed to obtain a microfabrication type glass in each example. Initially, Al(OH)₃ was used as the raw material, but was changed to Al₂O₃, and the β-OH value was adjusted for each example. The β-OH value of each example is shown in Table 1. In addition, in Examples 12 to 15, the charged glass compositions were the same, but the composition of easily volatile components such as F and Br varied depending on the melting, so that the compositions of the obtained glasses were not the same.

### <Physical Properties>

### (β-OH Value)

Using a Fourier transform infrared spectrophotometer (model number: FT/IR-4100 manufactured by JASCO Corporation), the absorbances at 3570 cm-1 and 3845 cm⁻¹ were measured, and the β-OH value was determined according to the following equation. The β-OH value of each example is shown in Table 1.

β-OH value (/mm)=(absorbance at 3570 cm⁻¹−absorbance at 3845 cm⁻¹)/t
t: thickness (mm) of glass sample

### (Difference in Crystal Precipitation Temperature)

The glass sample obtained above was crushed and measured using a differential thermal analyzer (Thermo plus TG8120 manufactured by RIGAKU Corporation) and a differential scanning calorimeter (Thermo Plus EVO2 DSC8271 manufactured by RIGAKU Corporation) under conditions that a sample weight was 30 mg to 60 mg and a heating rate was 10° C./min. On an exothermic peak due to crystal precipitation under uniform heating in the obtained chart, an extrapolation temperature of an inflection point at which heat generation started was defined as the crystal precipitation temperature. The extrapolation temperature was set to be an intersection temperature of an extension line of a portion where there is no change in amount of heat before heat generation occurs and an extension line of a point where a gradient of the change in amount of heat after the start of heat generation was the maximum.

Subsequently, the glass sample obtained above was subjected to the exposure using a photochemical mercury lamp (H-400P manufactured by Toshiba Corporation) so that the cumulative amount of the light having the wavelength of 280 nm to 360 nm is 2 J/cm² or more. The UV illuminance was measured by attaching an UV cumulative photometer (UIT-250 manufactured by Ushio Inc.) and a light receiver (UVD-S313 manufactured by Ushio Inc.).

The crystal precipitation temperature of the glass sample after the exposure was measured in the same manner as above.

A value obtained by subtracting the crystal precipitation temperature after the exposure from the crystal precipitation temperature before the exposure was defined as the difference in crystal precipitation temperature. The difference in crystal precipitation temperature of each example is shown in Table 1.

### <Evaluation on Microfabrication Property>

The microfabrication type glasses in Example 14 and Example 15 were subjected to the exposure and the heat treatment under the following conditions to precipitate crystals, and then etched for evaluating the microfabrication property.

Mask exposure was performed using a high-pressure mercury lamp (ultra-high-pressure mercury lamp USH-250BY manufactured by Ushio Inc.) under conditions such that the cumulative amount of a light having a wavelength of 280 nm to 360 nm was 2 J/cm² or more. Thereafter, a heat treatment at 545° C. was performed for 10 hours to precipitate crystals, and etching was performed with a 10% HF aqueous solution.

A micrograph for Example 14 after microfabrication is shown in (a) of the FIGURE, and a micrograph for Example 15 after microfabrication is shown in (b) of the FIGURE.

TABLE 1

| | | Example | Example | Example | Example | Example | Example | Example | Example |
|---|---|---|---|---|---|---|---|---|---|
| | | 1 | 2 | 3 | 4 | 5 | 6 | 7 | 8 |
| Composition type | | Refractive index variable type | | | | | | | |
| Physical | β-OH value | 0.100 | 0.070 | 0.069 | 0.069 | 0.066 | 0.063 | 0.063 | 0.059 |
| property | [/mm] | | | | | | | | |
| | Difference in | 24.2 | 13 | 10.4 | 28.8 | 28.2 | 14.5 | 11.4 | 23.9 |
| | crystal | | | | | | | | |
| | precipitation | | | | | | | | |
| | temperature | | | | | | | | |
| | [° C.] | | | | | | | | |

| | | Example | Example | Example | Example | Example | Example | Example |
|---|---|---|---|---|---|---|---|---|
| | | 9 | 10 | 11 | 12 | 13 | 14 | 15 |
| Composition type | | Refractive index variable type | | | Microfabrication type | | | |
| Physical | β-OH value | 0.044 | 0.036 | 0.032 | 0.094 | 0.135 | 0.185 | 0.206 |
| property | [/mm] | | | | | | | |
| | Difference in | 15 | 31.1 | 11 | 16 | 14 | 11 | 9 |
| | crystal | | | | | | | |
| | precipitation | | | | | | | |
| | temperature | | | | | | | |
| | [° C.] | | | | | | | |

As seen from the refractive index variable type glasses in Examples 1 to 11, which are Working Examples, not only the composition but also the β-OH value is an influencing factor for the difference in crystal precipitation temperature. Since the β-OH value in each of Examples 1 to 11 was 0.20/mm or less, the difference in crystal precipitation temperature thereof was 10° C. or more, which showed a good result.

In addition, in the case of the microfabrication type glass, in Examples 12 to 14 in which the β-OH value was 0.20/mm or less, the difference in crystal precipitation temperature was 10° C. or more, which also showed a good result. On the other hand, in Example 15 in which the β-OH value was more than 0.20/mm, the difference in crystal precipitation temperature was less than 10° C., which showed a poor result. Further, in the evaluation on microfabrication property, in Example 14, since the difference in crystal precipitation temperature was 10° C. or more, there were no etching defects in the exposed portion A and the unexposed portion B and a good microfabrication property was exhibited; and in Example 15, since the difference in crystal precipitation temperature was less than 10° C., etching defects were generated due to fine crystal precipitation in the unexposed portion B. This is thought to be because during the mask exposure, weak diffracted light is generated at an open portion through which ultraviolet rays (light) passes, and in the case where the difference in crystal precipitation temperature between exposure and non-exposure is small, even the weak diffracted light has the effect of promoting crystal precipitation due to being sensitive to light, and fine crystals tend to precipitate even in the unexposed portion, and as a result, a microfabrication shape deteriorates due to etching.

The present application is based on Japanese Patent Application No. 2023-124791 filed on Jul. 31, 2023, and the contents thereof are incorporated herein by reference.

What is claimed is:

1. A photosensitive glass, having a β-OH value of 0.20/mm or less.

2. The photosensitive glass according to claim 1, having a difference between a crystal precipitation temperature after an exposure and a crystal precipitation temperature before the exposure of 10° C. or more, the exposure being performed so that a cumulative amount of a light having a wavelength of 280 nm to 360 nm is 2 J/cm² or more.

3. The photosensitive glass according to claim 1, comprising, in mass %:
0.001% to 5% of Ag₂O, and
0.001% to 5% of CeO₂.

4. The photosensitive glass according to claim 1, comprising, in mass %:
20% to 80% of SiO₂,
1% to 20% of Al₂O₃,
0% to 20% of B₂O₃,
0% to 20% of Li₂O,
0% to 20% of Na₂O,
0% to 20% of K₂O,
1% to 20% of ZnO,
0% to 5% of F,
0% to 5% of Br,
0.001% to 0.5% of Ag₂O,
0.001% to 0.5% of CeO₂,
0% to 1.0% of Sb₂O₃, and
0% to 1.0% of SnO₂.

5. The photosensitive glass according to claim 1, being substantially free of Cr, Ni, V, Mn, and Co.

6. A production method for a photosensitive glass, the method comprising:
heating a glass raw material containing a photosensitizer component to obtain a molten glass;
molding the molten glass into a desired shape; and
annealing the molded glass,
wherein the method further comprises lowering a β-OH value of the photosensitive glass.

7. The production method for a photosensitive glass according to claim 6, wherein
the annealing is performed at a cooling rate from a temperature T1 to a temperature T2 of 1° C./min or less, the temperature T1 means an annealing point temperature, and the temperature T2 means a strain point temperature.
